(19) United States
(12) Patent Application Publication
(10) Pub. No.: US 2009/0059093 A1
(43) Pub. Date: Mar. 5, 2009

(54) IMAGE DISPLAY DEVICE AND METHOD FOR DISPLAYING IMAGES AND ADDITIONAL INFORMATION

(75) Inventors: XIAO-GUANG LI, Shenzhen City (CN); KUAN-HONG HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/202,388

(22) Filed: Sep. 1, 2008

(30) Foreign Application Priority Data
Aug. 31, 2007 (CN) 200710076750.7

(51) Int. Cl. H04N 5/66

(52) U.S. Cl. 348/739; 348/E05.133

(57) ABSTRACT

An exemplary image display device (1) includes a display unit (2) including a large primary display region (21) and a small secondary display region (22); a storage (5) storing image files; a display control unit (41) including an image display control unit (42) for displaying an image defined by one of the image files in the primary display region in a first display mode and displaying the image in the secondary display region in a second display mode, and an additional information display control unit (43) for displaying additional information in the secondary display region in the first display mode and displaying the additional information in the primary display region in the second display mode; and a mode switch unit (44) for signaling the display control unit to switch between the first and second display modes.

### CROSS-REFERENCE TO RELATED APPLICATIONS

This application is related to two copending U.S. patent applications, entitled “IMAGE DISPLAYER AND METHOD FOR DISPLAYING IMAGES AND ADDITIONAL INFORMATION,” Ser. No. 12/134217, filed on Jun. 6, 2008; and “IMAGE DISPLAYING DEVICE AND METHOD FOR DISPLAYING IMAGES AND RELATED INFORMATION,” Attorney Docket No. US12853, concurrently filed with the present application. Both of the copending applications are assigned to the same assignee as that of the present application. The disclosures of both of the copending applications are incorporated herein by reference.

### BACKGROUND

1. Technical Field

The present invention relates to an image display device and method for displaying images and additional information.

2. General Background

Whether using a traditional photo frame to display a paper photo or using a digital photo frame to display a digital photo, people may want to record photo-related information, such as the date, location, subject of the photo, and their feelings at the time of the photo. This information helps people recall precious moments or details.

Typically, people would add photo-related information by writing notes on the back of a paper photo. However, note writing is not possible for digital photos. Many digital cameras have the capability of applying a time and date stamp to digital photos. However, the stamp will generally be very small so as to not obscure the digital photo, making it difficult for people with poor eyesight to read. Furthermore, because digital cameras typically only offer date and time stamping, other details people wish to remember may be lost.

Some types of newer digital photo frame models are capable of also serving as a clock to provide current date and time information. Such information is generally displayed by overlapping the information on the photo in a very small font size in order to preserve the appearance of the photo. This can be difficult for people with poor eyesight to read.

Therefore, an improved image display device and method to display information is desired to overcome the above-described deficiencies.

### SUMMARY

In one embodiment, an image display device for displaying images and additional information includes: a display unit, including a primary display region and a secondary display region smaller than the primary display region; a storage configured for storing one or more image files and a catalog of the image files; a display control unit, including an image display control unit configured for displaying an image defined by at least one image file selected from the image files in the primary display region in a first display mode and displaying at least one of the image and a catalog of the image files in the secondary display region in a second display mode, an additional information display control unit configured for displaying additional information in the secondary display region in the first display mode and displaying the additional information in the primary display region in the second display mode; and a mode switch unit configured for signaling the display control unit to switch between the first display mode and the second display mode.

Other advantages and novel features will become more apparent from the following detailed description and when taken in conjunction with the accompanying drawings.

### BRIEF DESCRIPTION OF THE DRAWINGS

The components in the drawings are not necessarily drawn to scale, the emphasis instead being placed upon clearly illustrating the principles of the image display device and method for displaying images and additional information. In the drawings, like reference numerals designate corresponding parts throughout the various views.

FIGS. 1, 3, 5 and 7 show an exemplary image display device displaying images and additional information in a first display mode, in accordance with various embodiments of the present invention.

FIGS. 2, 4, 6, and 8˜11 show the same image display device displaying images and additional information in a second display mode, in accordance with various embodiments of the present invention.

FIG. 12 is a block diagram including hardware of an image display device used to display images and additional information in two different modes in accordance with a first embodiment of the present invention.

FIG. 13 is a block diagram including hardware of an image display device used to display images and additional information in two different modes in accordance with a second embodiment of the present invention.

FIG. 14 is a block diagram including hardware of an image display device used to display images and additional information in two different modes in accordance with a third embodiment of the present invention.

FIG. 15 is a flowchart of a method for displaying images and additional information in accordance with one embodiment of the present invention.

### DETAILED DESCRIPTION

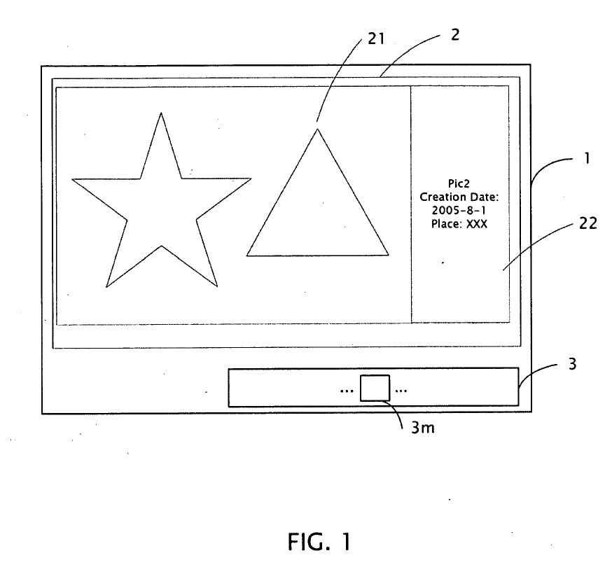

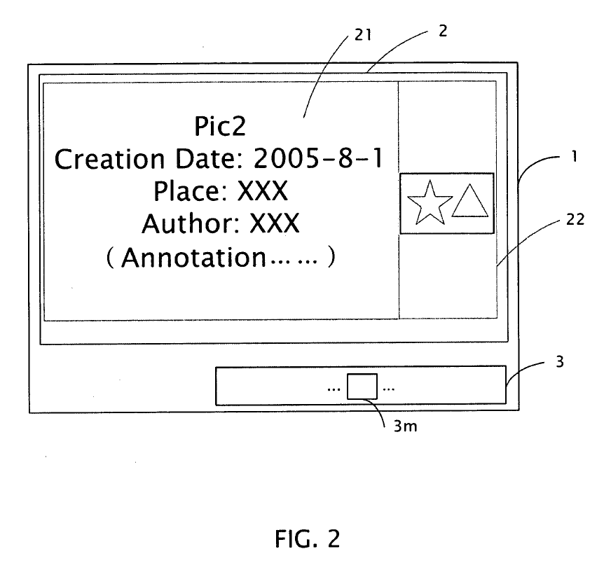

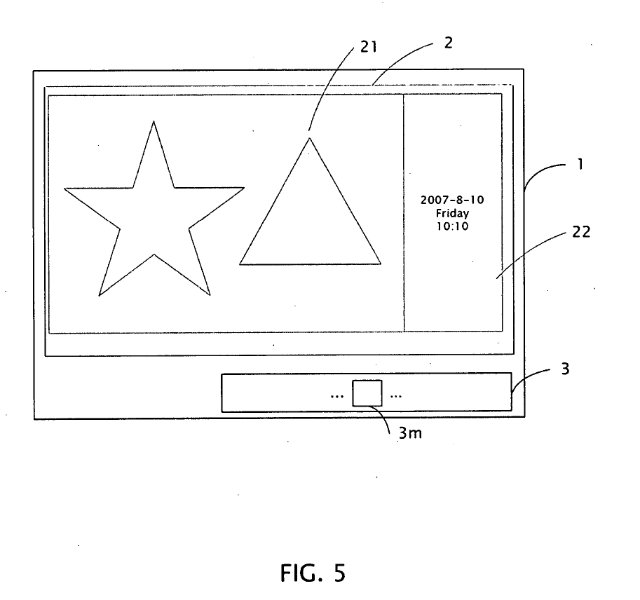

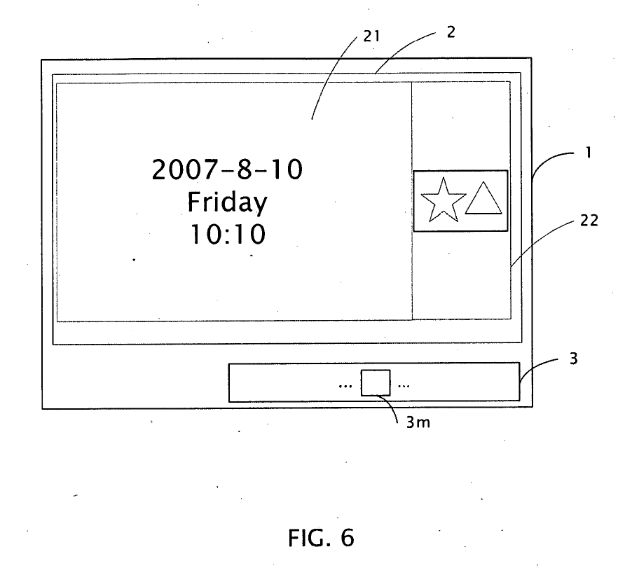

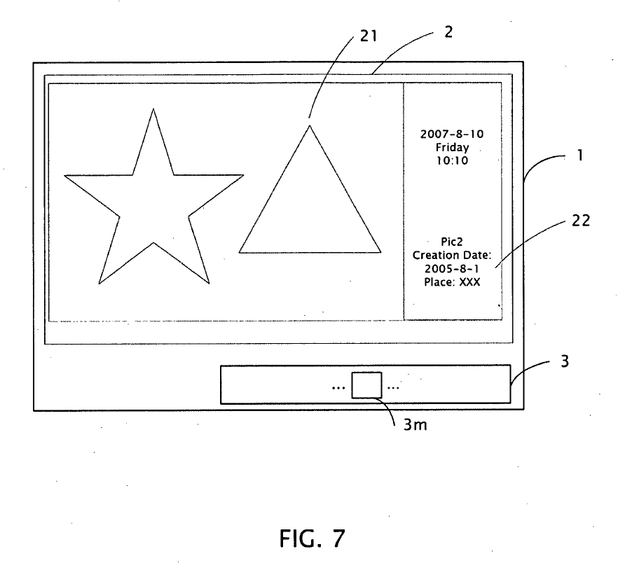

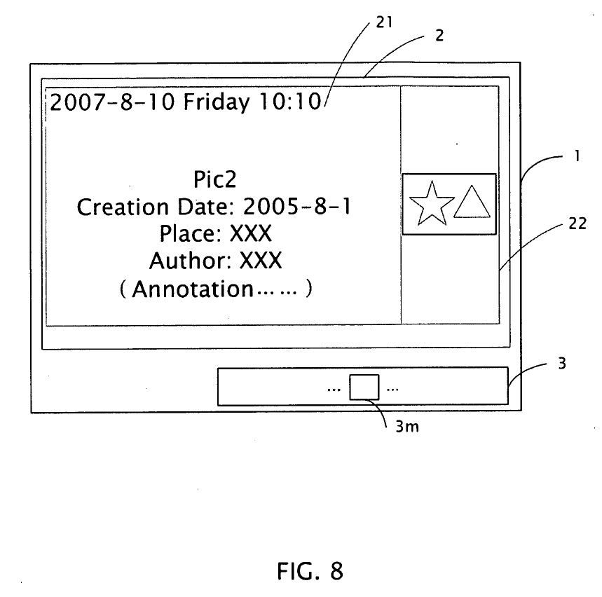

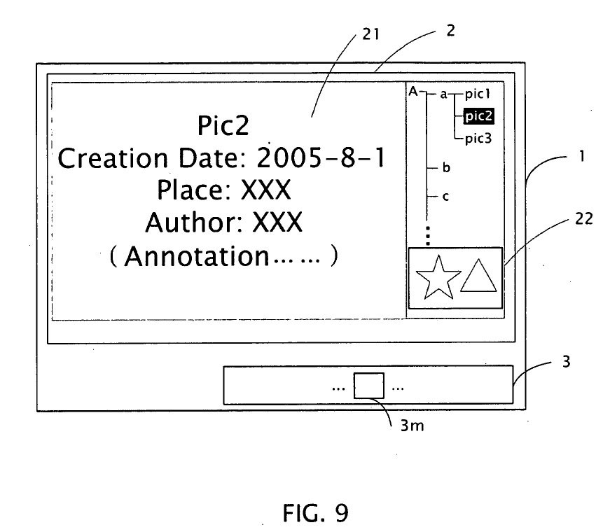

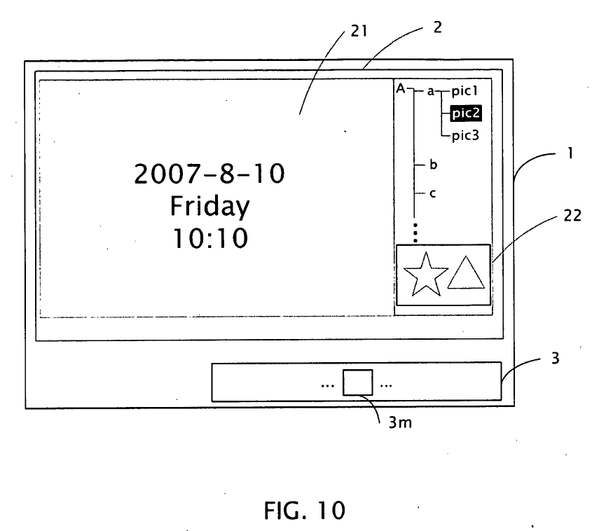

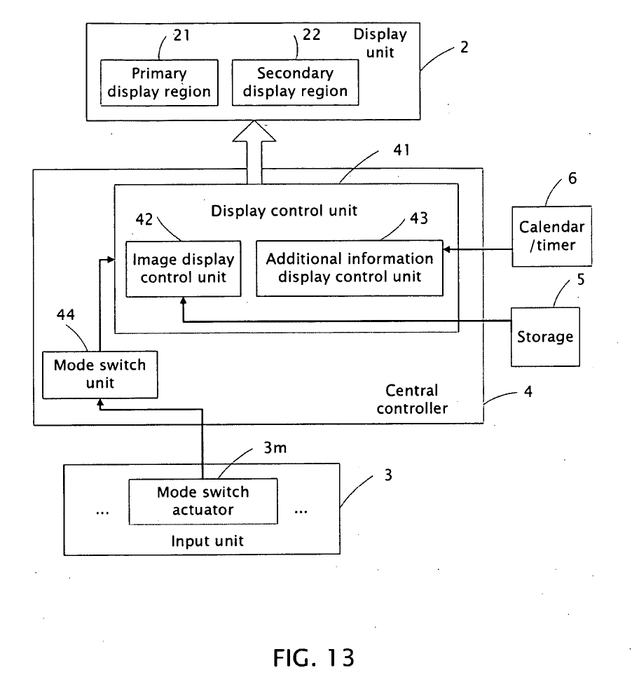

Referring now to the drawings in detail, FIGS. 1 through 11 show an image display device 1 in accordance with an exemplary embodiment. The image display device 1 includes a display unit 2 and an input unit 3. The display unit 2 is configured for displaying images and additional information in two different display modes. FIGS. 1, 3, 5, and 7 show the display unit 2 displaying an image and additional information in a first display mode, and FIGS. 2, 4, 6, and 8˜11 show the display unit 2 displaying the same image and additional information in a second display mode. The additional information shown in FIGS. 1˜4 and 9 is image-related information, such as the original generation (creation) date of the image and the place where the image was generated. The additional information shown in FIGS. 5, 6 and 10 is current date and time information, which is provided (generated) by a calendar/timer 6 (see, e.g., FIG. 13). The additional information shown in FIGS. 7, 8 and 11 includes both the image-related information and the current date and time information.

Generally, in the first display mode, the image is displayed in a primary display region 21 which occupies a major area of the display unit 2, and the additional information is displayed in a secondary display region 22 which occupies a minor area of the display unit 2. The additional information is reduced in size and in some instances only a portion of the additional information is displayed. In the second display mode, the image is displayed in the secondary display region 22 and the additional information is displayed in the primary display region 21. The image is reduced in size so as to fit the display area in the secondary display region 22. In contrast, the additional information is enlarged and typically all the content of the additional information can be displayed. A mode switch actuator 3m is included in the input unit 3. The mode switch actuator 3m is configured for triggering the image display device 1 to switch between the first display mode and the second display mode.

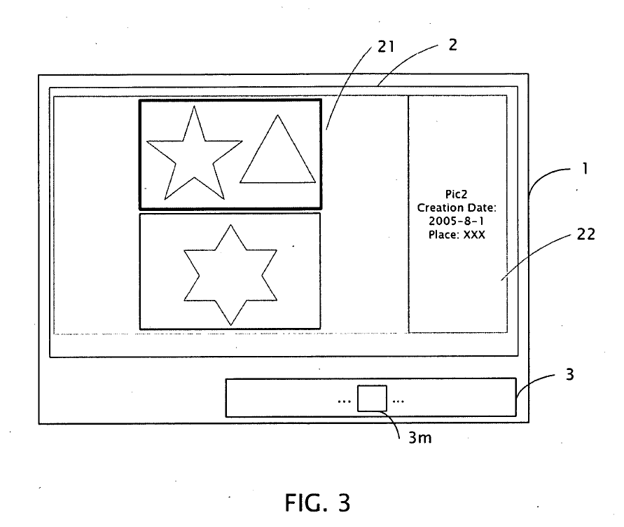

Referring to FIG. 3, typically, images in a predefined order are displayed in the primary display region 21 in the first display mode. The image is marked (e.g., highlighted) by a cursor (not labeled), and its image-related information is shown in the secondary display region 22. The cursor is moveable upon operations of users via the input unit 3, so that a desirable image is selected and its image-related information is displayed in the secondary display region 22.

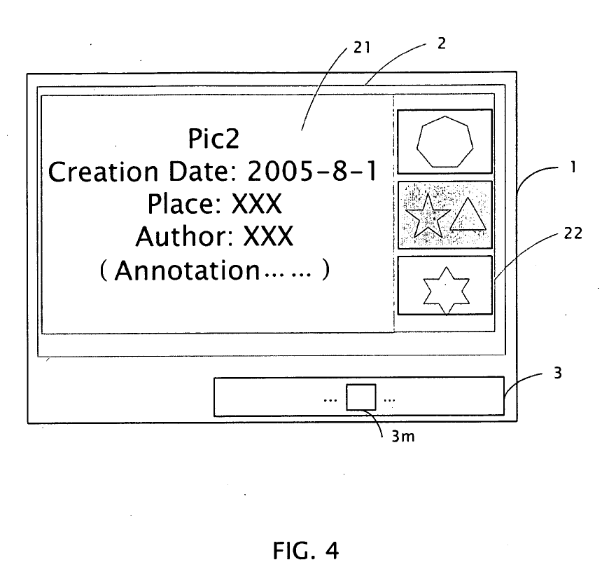

Referring to FIG. 4, typically, images in a predefined order are displayed in the secondary display region 22 in the second display mode. The image is marked (e.g., highlighted) by a cursor (not labeled), and its image-related information is displayed in the primary display region 21. The cursor is also movable upon operations of the users via the input unit 3, thereby enabling the users to select a desired image and read the image-related information of the desired image in the primary display region 22.

Referring to FIG. 9, a catalog of the image files is displayed in the secondary display region 22 in the second display mode. The catalog is accompanied by a reduced image of a marked (e.g., highlighted) image file, whose image-related information is concurrently displayed in the primary display region 22. In one embodiment, only a part of the catalog may be displayed in the secondary display region 22 in the second display mode. The catalog is scrollable so that the users are able to move a cursor (not labeled) to mark a desirable image file and read its image-related information in the primary display region 21. In another embodiment shown with FIG. 10, the current date and time information (instead of the image-related information relating to the marked image file) is concurrently displayed in the primary display region. In still another embodiment shown with FIG. 11, both the current date and time information and the image-related information relating to the marked image file are concurrently displayed in the primary display region 21.

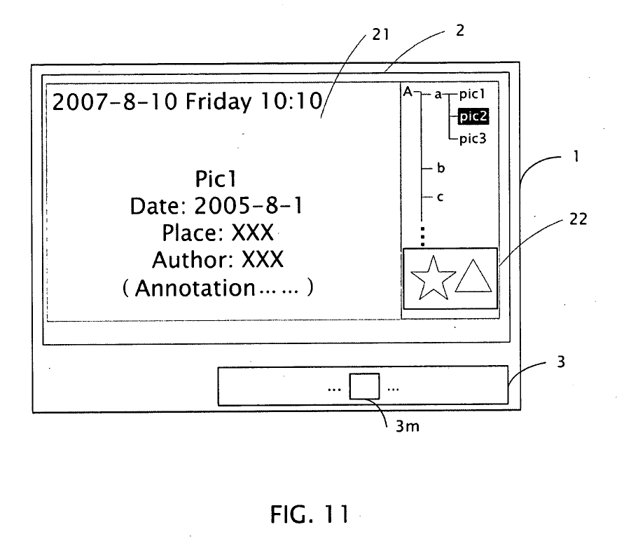

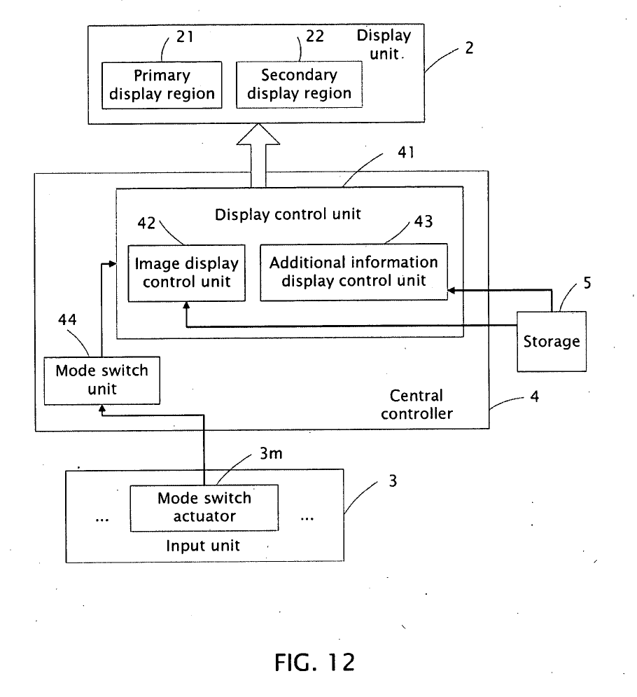

Referring to FIG. 12, hardware used to display images and additional information in accordance with a first embodiment is shown. A central controller 4 includes a display control unit 41 and a mode switch unit 44. The display control unit 41 includes an image display control unit 42 and an additional information display control unit 43. The image display control unit 42 is configured to obtain at least one of the image files and a catalog of the image files from a storage 5, and control the display of either or both of corresponding images and the catalog on the display unit 2. The additional information display control unit 43 is configured to obtain image-related information files from the storage 5 and control the display of the image-related information on the display unit 2.

Typically, the image-related information files are associated with the image files. The mode switch unit 44 is configured to receive mode switch signals from the mode switch actuator 3m, and to signal the display control unit 41 to switch between the first display mode and the second display mode.

Generally, in the first display mode, the image display control unit 42 controls the images displayed in the primary display region 21 and the additional information display control unit 43 controls the image-related information displayed in the secondary display region 22. The additional information display control unit 43 may control only a portion of the image-related information to be displayed in the secondary display region 22.

In the second display mode, the image display control unit 42 controls the images or the catalog of the image files or both to be displayed in the secondary display region 22. Typically, because the secondary display region 22 is much smaller than the primary display region 21, the image display control unit 42 controls the images to be displayed in a reduced size, so that the images fit in the secondary display region 22. In contrast, the additional information display control unit 43 controls the image-related information to be displayed in an enlarged size, so that all of the content of the image-related information can be clearly displayed (see, e.g., FIGS. 2 and 4). In another example, the image display control unit 42 controls the catalog to be displayed in a reduced size, so that the catalog (or a substantial portion thereof) fits in the secondary display region 22. In still another example, the image display control unit 42 controls both the catalog and the images to be displayed in a reduced size, so that the catalog (or a substantial portion thereof) and at least one of the images fits in the secondary display region 22 (see FIGS. 9˜11).

Referring to FIG. 13, hardware used to display images and additional information in accordance with a second embodiment is shown. In the second embodiment, a calendar/timer 6 is included. The calendar/timer 6 is typically a real time clock (RTC) and is configured for recording current date and time information. That is, the calendar/timer 6 is typically a single integrated unit. The additional information display control unit 43 in the second embodiment is configured to obtain the current date and time information from the calendar/timer 6. The additional information display control unit 43 is also configured to display the current date and time information in the secondary display region 22 in the first display mode, and in an enlarged size in the primary display region 21 in the second display mode.

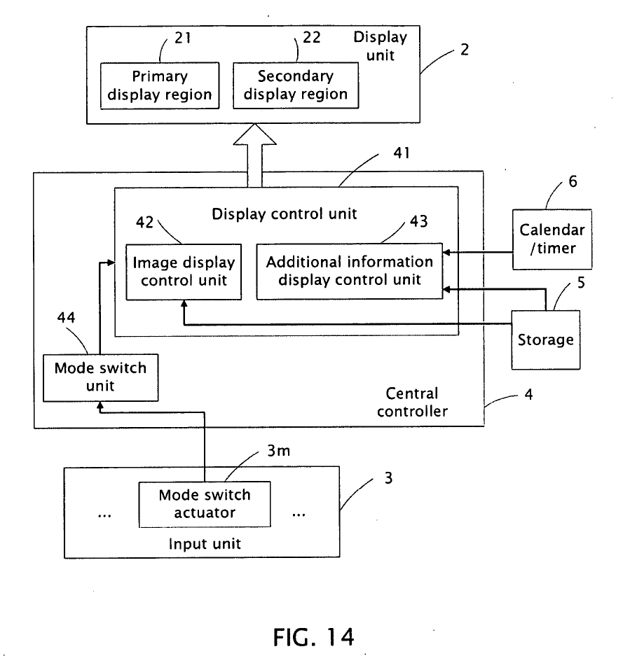

Referring to FIG. 14, hardware used to display images and additional information in accordance with a third embodiment is shown. In the third embodiment, the additional information display control unit 43 obtains both the image-related information file and the current date and time information. The additional information display control unit 43 can display either or both of the image-related information and the current date and time information in the secondary display region 22 in the first display mode, and in the primary display region 21 in the second display mode.

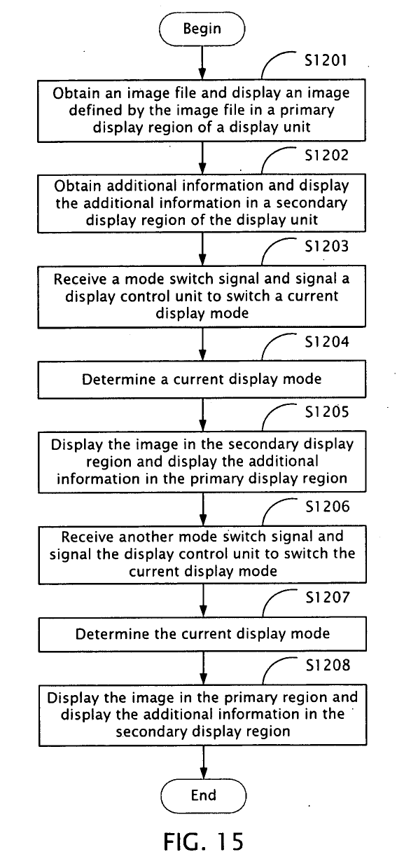

Referring also to FIG. 15, a flowchart of a method for displaying images and additional information in accordance with one embodiment is shown. First in step S1201, the image display control unit 42 obtains an image file from the storage 5, and displays an image defined by the image file in the primary display region 21 of the display unit 2. In step S1202, the additional information display control unit 43 obtains additional information, and displays the additional information in the secondary display region 22 of the display unit 2.

The additional information display control unit 43 may obtain an image-related information file that corresponds to the image file, the current date and time information from the calendar/timer 6, or both, and display the obtained information in the secondary display region 22. The additional information display control unit 43 may display only a portion of the additional information in the secondary display region 22. The display control unit 41 simultaneously generates a current display mode record to record the current display mode.

In step S1203, the mode switch unit 44 receives a mode switch signal from the mode switch actuator 3m and signals the display control unit 41 to switch the current display mode. In step S1204, the display control unit 41 determines the current display mode according to the current display mode record. In step S1205, the image display control unit 42 displays the image in the secondary display region 22, and the additional information display control unit 43 displays the additional information in the primary display region 21. Generally, the image display control unit 42 may reduce the image size, so that the image fits in the display area of the secondary display region 22. The additional information display control unit 43 may enlarge the additional information and display all of the content of the additional information in the primary display region 21. The display control unit 41 simultaneously updates the current display mode record and keeps the current display mode record up to date.

In one alternative embodiment, in step S1205 the image display control unit 42 obtains a catalog of the image files stored in the storage 5 from the storage 5 and displays the catalog of the image files in the secondary display region 22, while the additional information display control unit 43 displays the additional information in the primary display region 21. In another alternative embodiment, in step S1205 the image display control unit 42 obtains both an image file and a catalog of the image files from the storage 5 and displays both the image and at least part of the catalog of the image files in the secondary display region 22, while the additional information display control unit 43 displays the additional information in the primary display region 21.

In step S1206, the mode switch unit 44 receives another mode switch signal and signals the display control unit 41 to switch the current display mode. In step S1207, the display control unit 41 determines the current display mode according to the current display mode record. In step S1208, the image display control unit 42 displays the image in the primary display region 21, and the additional information display control unit 43 displays the additional information in the secondary display region 22. The display control unit 41 simultaneously updates the current display mode record and keeps the current display mode record up to date.

Other examples and/or variations of the above-described embodiments are shown in FIGS. 1 and 5˜8.

Although preferred and exemplary embodiments have been specifically described above, the invention is not to be construed as being limited thereto. Various changes or modifications may be made to the embodiments without departing from the scope and spirit of the invention.

What is claimed is:

1. An image display device for displaying images and additional information, comprising:
a display unit comprising a primary display region and a secondary display region, the secondary display region being smaller than the primary display region;
a storage configured for storing one or more image files;
a display control unit comprising:
an image display control unit configured for displaying at least one image defined by at least one image file selected from the image files in the primary display region in a first display mode and displaying the at least one image in the secondary display region in a second display mode; and
an additional information display control unit configured for displaying additional information in the secondary display region in the first display mode and displaying the additional information in the primary display region in the second display mode; and
a mode switch unit configured for signaling the display control unit to switch between the first display mode and the second display mode.

2. The image display device of claim 1, wherein the image is reduced in size to fit the secondary display region in the second display mode.

3. The image display device of claim 1, wherein the storage is further configured for storing a catalog of the image files, and the image display control unit is further configured for displaying at least one of the image and the catalog of the image files in the secondary display region in the second display mode.

4. The image display device of claim 3, wherein at least part of the catalog is displayed in the secondary display region in the second display mode.

5. The image display device of claim 1, wherein the additional information is enlarged in size in the second display mode.

6. The image display device of claim 1, wherein only a portion of the additional information is displayed in the first display mode.

7. The image display device of claim 1, further comprising a calendar/timer for recording current date information and current time information.

8. The image display device of claim 7, wherein the additional information comprises the current date information and the current time information.

9. The image display device of claim 1, wherein the storage is further configured for storing image-related information relating to the image, and the additional information comprises the image-related information.

10. A method for displaying images and additional information, comprising:
obtaining an image file from a storage and displaying an image defined by the image file in a primary display region of a display unit;
obtaining additional information and displaying the additional information in a secondary display region of the display unit, the secondary display region being smaller than the primary display region;
receiving a mode switch signal;
displaying the image in the secondary display region; and
displaying the additional information in the primary display region.

11. The method of claim 10, further comprising: obtaining a catalog of image files comprising the image file from the storage and displaying the catalog of the image files in the second display region after receiving the mode switch signal.

12. The method of claim 11, wherein only a portion of the catalog is displayed in the second display region.

13. The method of claim 10, further comprising:
receiving another mode switch signal; and
displaying the image in the primary display region and displaying the additional information in the secondary display region.

14. The method of claim 10, wherein the image is reduced in size when displayed in the secondary display region.

15. The method of claim 10, wherein the additional information is enlarged in size when displayed in the primary display region.

16. The method of claim 10, wherein the additional information comprises current date information and current time information.

17. The method of claim 10, wherein the additional information comprises image-related information relating to the image.

18. The method of claim 10, wherein only a portion of the additional information is displayed in the secondary display region.
